(19) United States
(12) Patent Application Publication
(10) Pub. No.: US 2006/0232928 A1
(43) Pub. Date: Oct. 19, 2006

(54) Heat sink for multiple components

(76) Inventors: Wade D. Vinson, Magnolia, TX (US); Thomas T. Hardt, Missouri City, TX (US); Thomas G. Bumby JR., Sugar Land, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/110,462

(22) Filed: Apr. 19, 2005

(51) Int. Cl. G06F 1/20

(52) U.S. Cl. 361/687

(57) ABSTRACT

In accordance with certain embodiments, a computer system having multiple electronic components, and a heat sink having cantilever portions disposed against the multiple electronic components.

### BACKGROUND

This section is intended to introduce the reader to various aspects of art, which may be related to various aspects of the present invention that are described and/or claimed below. This discussion is believed to be helpful in providing the reader with background information to facilitate a better understanding of the various aspects of the present invention. Accordingly, it should be understood that these statements are to be read in this light, and not as admissions of prior art.

Certain components of electronic devices generate a significant amount of heat, which should be removed to ensure proper operation of the particular electronic device. For example, a central processing unit (CPU) of a computer generates considerable heat. Consequently, various cooling techniques have been developed to remove heat produced within an electronic device. Such techniques may employ fans, blowers, heat sinks, heat pipes, vapor chambers, and other heat transfer devices to maintain acceptable operating temperatures of the components housed within the electronic device. In the case of a heat sink, it may mount to a CPU within a computer to maintain the CPU at an appropriate operating temperature. Certain applications may mount the heat sink with glue, solder, thermal grease, and/or multiple screws. Furthermore, some heat sinks may include a plurality of fins to increase the heat transfer from the CPU to the environment. In addition, fans may circulate air in the vicinity of the heat sink to promote a greater rate of heat transfer.

The use of heat sinks, however, may be problematic in computers having multiple CPU's. Typically, an independent heat sink is separately mounted to each CPU, and thus the number of heat sinks equals the number of CPU's. Unfortunately, the use of several independent heat sinks increases cost and complexity in the manufacturing, assembly, and repair of the electronic devices. Multiple heat sinks employed in multi-processor servers, for example, may be relatively expensive and generally require special servicing. Moreover, multiple mounting hardware may be needed, consuming space, and adding cost and complexity to assembly of the multi-processor devices. Further, in multi-processor devices, there may be limited fin area for each CPU. Also, if active cooling is employed, a fan may be dedicated to each heat sink/CPU combination, increasing the number of fans and associated noise and power consumption. Further, the presence of mounting hardware for multiple heat sinks may restrict airflow of the fans.

### BRIEF DESCRIPTION OF THE DRAWINGS

Exemplary embodiments of the present invention may be apparent upon reading of the following detailed description with reference to the drawings in which:

FIG. 1 is a top cross-sectional view of an electronic device containing a heat sink having cantilever portions mounted over two components in accordance with embodiments of the present invention;

FIG. 2 is a side cross-sectional view of the electronic device of FIG. 1 having the cantilevered heat sink in accordance with embodiments of the present invention;

FIG. 3 is a top cross-sectional view of an electronic device having the cantilevered heat sink mounted over two components in accordance with embodiments of the present invention;

FIG. 4 is a side view of a rack system having a plurality of rack devices, each including a heat sink having cantilever portions mounted atop of two components in accordance with embodiments of the present invention;

FIG. 5 is section view of the heat sink of FIG. 4, the heat sink having channels configured to receive heat pipes in accordance with embodiments of the present invention.

FIG. 6 is a top view of a heat sink having cantilever portions in accordance with embodiments of the present invention; and

FIG. 7 is a side view of the heat sink of FIG. 6 depicting elevated component mounting surfaces.

### DESCRIPTION OF SPECIFIC EMBODIMENTS

One or more specific embodiments of the present invention will be described below. In an effort to provide a concise description of these embodiments, not all features of an actual implementation are described in the specification. It should be appreciated that in the development of any such actual implementation, as in any engineering or design project, numerous implementation-specific decisions may be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

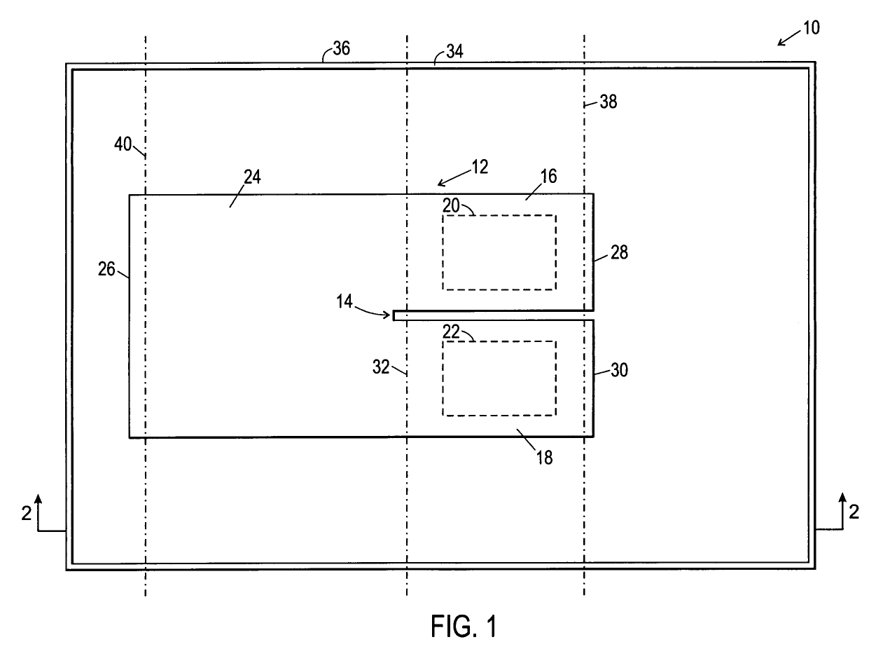

FIG. 1 is a top cross-sectional view of an electronic device 10 containing a heat sink 12 having a cantilever cut 14 and cantilever portions 16 and 18 mounted over two electronic components 20 and 22. This single heat sink 12 removes heat from both components 20 and 22, and the cantilever cut 14 facilitates proportional compression (and mounting) of the single heat sink 12 against both components 20 and 22. The cantilever portions 16 and 18 can flex somewhat independently of each other, and may accommodate components having different dimensional values (e.g., different heights) from each other. The amount of flex or flex angle of the portions 16 and 18 can depend, for example, on the length of the cut 14. In certain embodiments, the heat sink 12 and components 20 and 22 have mating surfaces that are generally flat and smooth to advance surface-to-surface contact, and thus advance heat transfer from the components 20 and 22 to the heat sink 12. Further, the substantially uniform pressure advantageously compresses a thermal interface material (TIM) disposed between the heat sink 12 and components 20 and 22. It should be noted that the heat sink 12 and components 20 and 22 can be mounted to a printed circuit board (not illustrated), such as a motherboard.

The illustrated heat sink 12 includes a base 24 extending to a base end 26, such that the heat sink 12 has a greater volume and surface area to increase its ability to transfer heat away from the components 20 and 22. This increase in volume and surface area is advantageously shared by the two components 20 and 22, such that each component 20 and 22 can distribute heat to regions directly above the respective component, above the other component, and to lateral regions away from the components 20 and 22. To further increase heat-transfer surface area, the heat sink 12 may also have one or more levels of convective members (e.g., pins, fins, or other protruding members) on the cantilever portions 16 and 18 and/or on the base 24. The convective members may be situated on the top and/or the bottom of the heat sink 12.

In certain embodiments, the convective members are positioned in the pathways of the inlet and/or outlet airflows of a centrifugal blower, an axial fan, or another air moving device. Exemplary air flow rates are in the range of 20 to 60 cubic feet per minute (cfm). The air flow rate may vary within this range, as well as outside of this range, depending on the amount of convective members, the number of blowers or fans, the amount of heat generated by the components 20 and 22, the desired operating temperature of the components 20 and 22, the ambient air temperature, and so forth. In certain examples, the airflow through one or more exemplary blowers can be reduced because the extended base 24 portion advantageously provides extra fins to be shared between the two components 20 and 22 having varying heat loads.

As indicated, the cantilever portions 16 and 18 are separated by the cantilever cut 14 and include cantilever ends 28 and 30, respectively. The cantilever ends 28 and 30, base end 26, the fulcrum axis 32, and intermediate regions along the heat sink 12 may receive mounting hardware and fastening elements, such as fasteners, screws, posts, springs, pins, and so on, to promote even mounting of the heat sink 12 to the components 20 and 22. The position and dimensions of the cantilever portions 16 and 18, cantilever cut 14, base 24, and fulcrum axis 32 may vary depending on desired compression between the heat sink 12 and components 20 and 22, placement of the components 20 and 22, space considerations, the desired heat transfer, and so forth.

As illustrated in FIG. 1, the fulcrum axis 32, cantilever-end axis 38, and base-end axis 40 denote positions where force is applied via fastening elements and/or fulcrum mechanisms. The fastening elements and fulcrum mechanisms function to secure the heat sink 12 to the printed circuit board (PCB) and to apply and adjust the compressive force of the heat sink 12 (cantilever portions 16 and 18) against the components 20 and 22. A variety of fastening and fulcrum configurations can be employed along three axes 32, 38, and 40 and intermediate regions. Moreover, the fulcrum axis 32 may be positioned at various positions along the heat sink 12, including at the ends 26, 28, and 30 of the heat sink 12. The selected length of the cantilever cut 14 and the selected position of the fulcrum axis 32 may address space considerations, varying surface tolerances of the components 20 and 22, and so on.

It should be noted that the heat sink 12 and components 20 and 22 may be mounted within the housing 36 (having a wall 34) of the electronic device 10. The electronic device 10 also can include a variety of other electronic devices and components, such as a processor, random access memory, a hard drive, a graphics processing module, an audio processing module, removable media drives, input/output ports, and so forth. In certain embodiments, the electronic device 10 is a computer system, such as a desktop computer, a laptop computer, a tablet personal computer, a personal digital assistant, or a rack mount computer. By further example, the electronic device 10 may be a server, such as a floor mount or a rack mount server.

The illustrated heat sink 12 can be configured to facilitate heat transfer by a variety of techniques, including thermal conduction and convection, evaporative cooling, and so on. In this example, the heat sink 12 and its conductive member are formed of a thermally conductive material, which can include aluminum, copper, and so forth. The heat sink 12 includes a conductive member, such as a metal rod or plate, which conducts heat away from the components 20 and 22. In certain embodiments, thermal interface material (TIM) is disposed between the surface of the heat sink 12 and the surfaces of the components 20 and 22 to increase conductive heat transfer from the components 20 and 22 to the heat sink 12. Furthermore, as indicated, the heat sink 12 can include a plurality of convective members, such as pins, fins, or other protruding members, positioned along the heat sink 12 to increase the surface area of the heat sink 12, thereby facilitating convective heat transfer away from the heat sink 12. Fins can be disposed on the top or bottom of the heat sink 12, and can include one or more layers of fins.

Also, as described above, the heat transfer volume (e.g., for thermal conduction) and the area (e.g., for thermal convection) of the heat sink 12 is shared between the components 20 and 22, such that the heat sink 12 provides each component 20 and 22 with a greater capacity for removing heat in a relatively smaller region of the housing 34 as compared to independent heat sinks disposed on each of the components 20 and 22. For example, the heat sink 12 approximately doubles the heat transfer merely by sharing the portions of the heat sink 12 directly above the components 20 and 22, rather than each component only having the capacity to transfer heat to a heat sink directly overhead. In addition, the lateral region of the heat sink 12 simultaneously increases the cooling capacity associated with both components, rather than using a similarly sized structure separately for each component. Thus, the shared heat sink 12 increases cooling capacity for both heat sinks in a fraction of the space, e.g., half the space for two components, one third the space for three components, and so forth.

Further, in certain embodiments, the heat sink 12 can include a heat pipe and/or vapor chamber to promote heat dissipation from the components 20 and 22. For example, a heat pipe having a working fluid or a vapor chamber having a working fluid may be installed or constructed in the base 24 to provide for evaporative cooling via evaporation and condensation of the working fluid (e.g., water, ammonia, etc.). In the case of a vapor chamber, one embodiment is formed of a non-circular cavity within the heat sink, wherein the cavity has a height in an exemplary range of 2-10 millimeters (mm). However, vapor chambers having other shapes and dimensions outside this exemplary range may be employed within the heat sink 12. Moreover, as appreciated by those of ordinary skill in the art, a heat pipe or vapor chamber may include a wick structure on an inner surface of the cavity to facilitate capillary action of the working fluid.

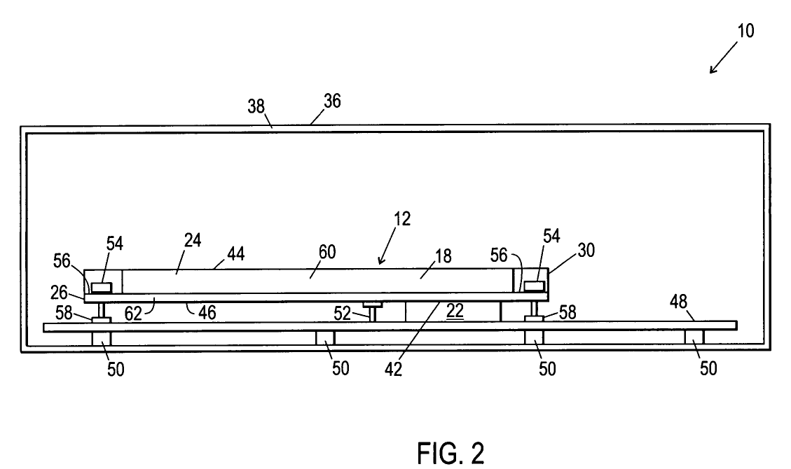

FIG. 2 is a side view taken along section line 2-2 of FIG. 1 depicting the electronic device 10 having a cantilevered heat sink 12. As illustrated, a component mounting surface 42 of cantilever portion 18 contacts the surface of the component 22. Optionally, a thermal interface material (TIM) can be installed between the surface 42 and the surface of the component 22. The heat sink 12 has a similar mounting surface on cantilever portion 16 which contacts the surface of component 20 (see FIG. 1). The heat sink 12 includes a top 44 and a bottom 46, and is mounted to a printed circuit board (PCB) 48, such as a motherboard, backplane, etc. As illustrated, the PCB 48 is coupled to supports 50 within the housing 36.

One or more fulcrums 52 are positioned underneath the bottom 46 of the heat sink 12 to provide for the fulcrum axis 32 (see FIG. 1). The fulcrum 52 may mount to the PCB 48 as illustrated, or the fulcrum 52 may extend through the PCB 48 to the wall 34 of the housing 36. The fulcrum 52 can incorporate a variety of configurations. For example, the fulcrum 52 may include a post having a head as depicted in FIG. 2. On the other hand, the fulcrum 52 may be a fastener inserted through the heat sink 12, which secures the heat sink 12 to the PCB 48, and which provides for a fulcrum point along the axis 32 (see FIG. 1). Moreover, in certain embodiments, the fulcrum 52 includes a spring mechanism to provide resiliency along the fulcrum axis 32. In other embodiments, the fulcrum 52 is a crush limiting spool positioned underneath the heat sink 12 with or without springs. In yet other embodiments, the fulcrum 52 comprises a pin having a spring positioned underneath the heat sink 12. Furthermore, more than one fulcrum 52 may be positioned along the axis 32 or at other locations along the heat sink 12. The selected configuration of the fulcrum(s) 52 may depend, for example, on the particular fastening and compression needs. The fulcrum(s) 52 and fulcrum axis 32, in conjunction with the cantilever portions 16 and 18, advantageously facilitate even-mounting of the heat sink 12 to the components 20 and 22, and accommodate components 20 and 22 of different positions and dimensions (e.g., height, surface area, etc.), for example.

As illustrated, screws 54 inserted through holes in the heat sink 12 secure the heat sink 12 to the PCB 48. In addition, the screws 54 can be rotated to adjust the compressive force between the heat sink 12 and the components 20 and 22. In certain embodiments, the head of the screws 54 rest in recessed areas 56 formed in the convective members 60 (e.g., fins) on the heat sink 12. The screws 54 may mate with fastening elements 58 (e.g., nuts) disposed on the PCB 48, as illustrated, or with fastening elements disposed on the wall 34 of the housing 36, and so on. The screws 54 may be rotated with a tool, such as a screwdriver, or rotated by hand (i.e., if the screws 54 are thumb screws), or a combination thereof. In certain embodiments, the screws 54 facilitate 30-70 pounds per square inch (psi) compression against the components 20 and 22 in a substantially uniform manner to avoid high pressure points relative to the remainder of the component surface. Other embodiments may provide for compression outside of this exemplary range.

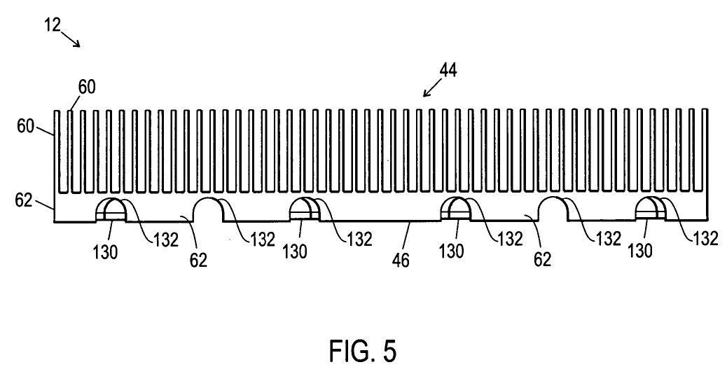

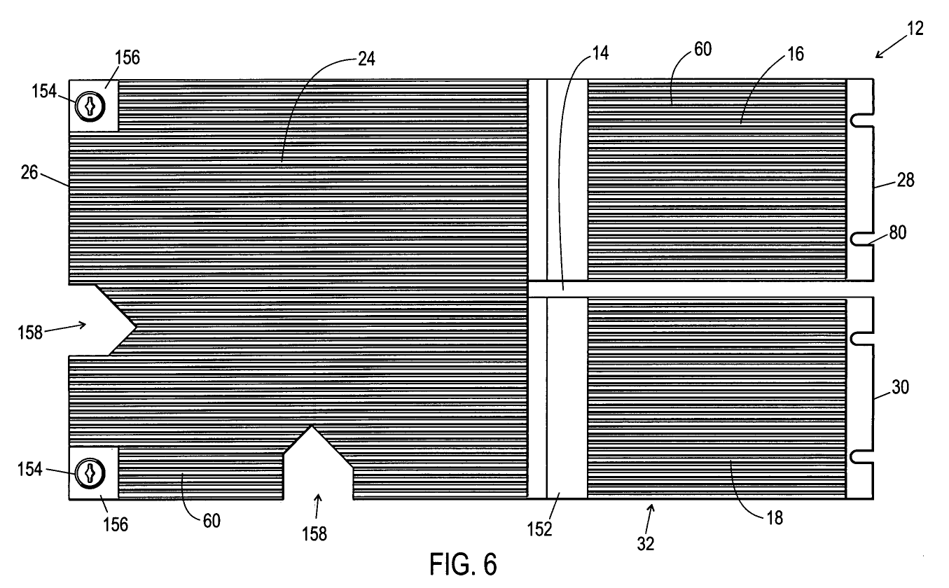

Again, the heat sink 12 can include a variety of heat transfer parts. For example, the heat sink 12 may include convective members 60, such as fins (see FIGS. 5 and 6), which increase the heat-transfer surface area of the heat sink 12. Moreover, as discussed, the heat sink 12 includes a conductive member 62 (e.g., plate), which provides structure for the heat sink 12 and which provides volume to conduct heat away from the components 20 and 22. In the illustrated embodiment, the conductive member 62 is an elongated member having the cantilever portions 16 and 18 and having a base portion 24 that laterally extends from the cantilever portions 16 and 18. In operation, the conductive member 62 conducts heat away from the components 20 and 22 laterally long the heat sink 12, thereby distributing the heat over a greater volume and surface area as compared to the individual components 20 and 22. As a result of this conductive heat distribution, the heat from the components 20 and 22 is also convected from the heat sink 12 to the environment over a greater region and surface area throughout the electronic device 10. Further, as discussed, one or more forced-convection mechanisms, such as axial fans or centrifugal blowers, may be disposed within the electronic device 10 to further promote heat dissipation from the components 20 and 22 to the environment via the heat sink 12.

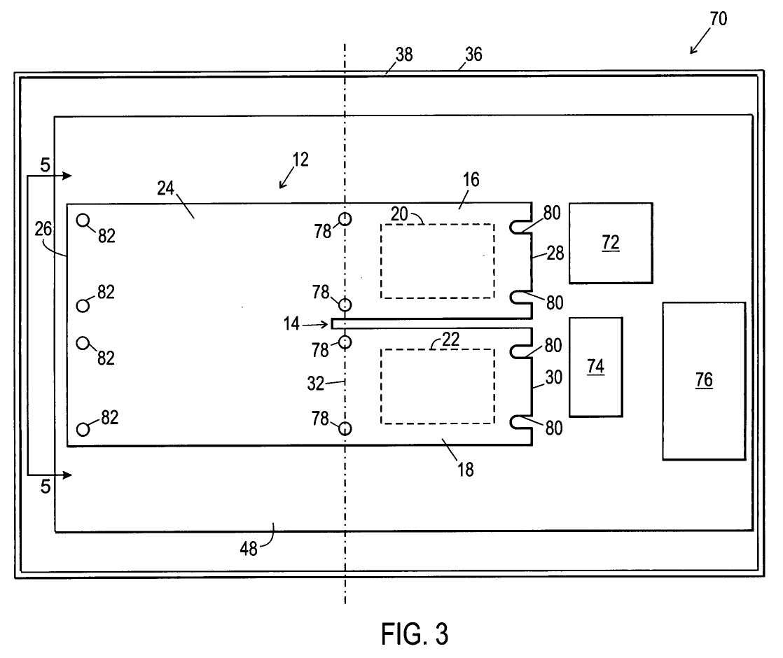

FIG. 3 is a top cross-sectional view of an electronic device 70 having a heat sink 12 cantilevered-mounted over two components 20 and 22. The electronic device 70 in this alternate configuration includes additional components 72, 74, and 76 disposed adjacent to the heat sink 12 within the housing 36 of the electronic device 70. These components 72, 74, and 76 can include processors, random access memory, hard drives, audio processing modules, video processing modules, and so forth.

In the illustrated embodiment, fasteners 78, in lieu of the fulcrum 52 of FIG. 2, are positioned along the fulcrum axis 32. The fasteners 78 couple the heat sink 12 to the PCB 48 and provide fulcrum points along the axis 32 for the cantilever portions 16 and 18. Further, in lieu of the screws 54 depicted in FIG. 2, toe-in notches 80 (generally U-shaped) disposed at the cantilever ends 28 and 30 mate with appropriate hardware within the electronic device 70, thereby further securing the heat sink 12 within the electronic device 70. Such appropriate hardware may include toe-in spools, shoulder screws, posts coupled to the PCB 48, and so on. Also, as illustrated, fasteners 82 in lieu of screws at the base end 26, secure the heat sink 12 within the electronic device 70. Moreover, the fasteners 78 and 82 and the toe-in notches 80 facilitate even-compression mounting of the cantilever portions 16 and 18 of the heat sink 12 to the components 20 and 22, respectively. Again, a variety of fastening and fulcrum mechanisms may be applied along the fulcrum axis 32, cantilever ends 28 and 30, base end 26, and at intermediate areas along the heat sink 12, to apply and adjust the compressive force of the heat sink 12 (cantilever portions 16 and 18) against the components 20 and 22. Moreover, a torque wrench or other tool may be employed where appropriate.

As indicated with the previous configurations, the shared portions of the heat sink 12 significantly increase the cooling capacity associated with each component 20 and 22. In operation, the heat sink 12 dissipates heat generated by the components 20 and 22 by conducting the heat throughout the volume of the heat sink 12, which includes volumes outside the typical region of a heat sink directly above the respective components 20 or 22. The heat sink 12 also convects heat away from the surface of the heat sink 12, which includes areas in addition to the typical area (e.g., fins or pins) of a heat sink directly above the respective component 20 or 22. For example, the base 24 portion provides the illustrated heat sink 12 with two, three, or another factor times the number of convective members as compared to a simple top mount heat sink. As a result, the heat sink 12 multiples of greater conductive and convective cooling as compared to the simple top mount heat sink. This increase in conductive and convective cooling is synergistically shared in the heat dissipation of the two components 20 and 22, while not proportionately increasing the space consumption of the heat sink 12 if such cooling capacities were desired for each component independently from one another.

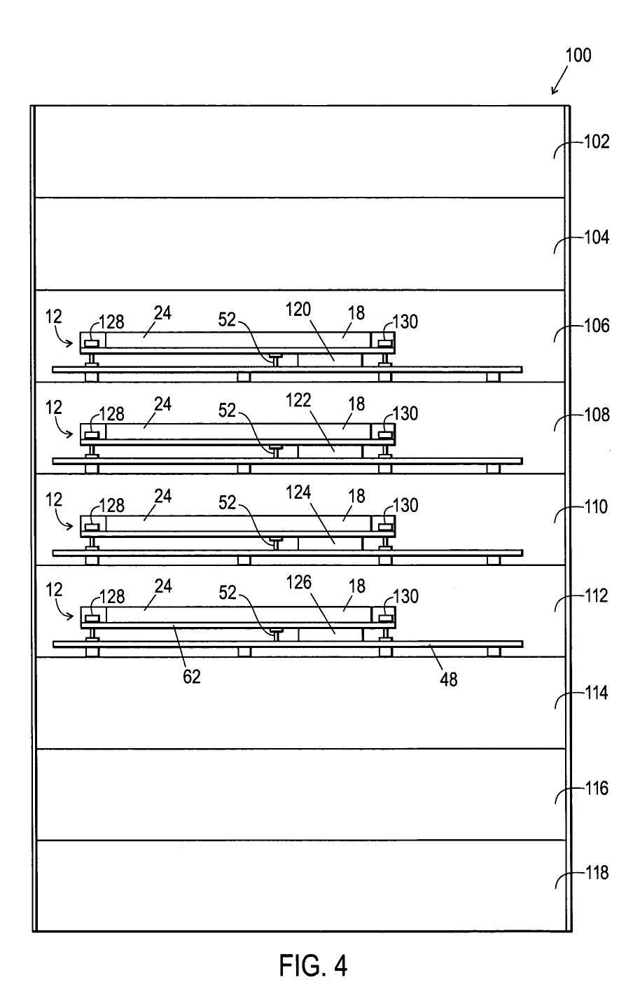

FIG. 4 is a side view of a rack system 100 having a plurality of rack devices 102 through 118, wherein the rack devices 106 through 112 include the cantilevered heat sink 12 of FIG. 1. In certain embodiments, these rack devices 102 through 118 include servers, storage media enclosures, switches, keyboard, monitors, power distribution, and so forth. The cantilever portions 18 of the illustrated heat sinks 12 are mounted over components 120, 122, 124, and 126 depicted in the foreground within each of the respective rack devices 106, 108, 110, and 112. As discussed above, these components 120, 122, 124, and 126 can include processors, random access memory, hard drives, graphics modules, audio modules, and other electronic devices. Further, the cantilever portion 16 (see FIGS. 1 and 3) is mounted over similar components. The fulcrum 52 and fastening elements 128 and 130 facilitate even-mounting of the heat sinks 12 to the illustrated components 120, 122, 124, and 126, and to the similar components.

Again, referring to FIG. 4 and generally to FIGS. 1-3, the base 24 portion or elongated structure of the heat sink 12 increases the volume and surface area of the heat sink 12. The increased volume significantly increases heat transfer by thermal conduction through the heat sink 12 away from the components 120, 122, 124, and 126 residing under cantilever portion 18, and also from the other components residing under cantilever portion 16 (not illustrated). The additional surface area significantly increases heat transfer by thermal convection away from the heat sink 12 and, thus, away from the components. Given that each component shares the volume and surface area associated with the base portion 24 lateral to the components and directly above the other component, each component has a substantially greater cooling capacity via conduction and convection, without a proportioned increase in space consumption typical of independent and separate heat sinks. This is particularly beneficial for tight rack spaces, such as 1U or smaller rack spaces.

FIG. 5 is an end view of the heat sink 12 taken along section line 5-5 of FIG. 3 in accordance with certain embodiments. To enhance illustration of the convective members 60 (e.g., pins or fins), the fastening elements of the heat sink 12 are not depicted. Again, the bottom 46 of the heat sink 12 along the conductive member 62 includes the mounting surfaces (e.g., mounting surface 42 of cantilever portion 18) of the heat sink 12, which mounting surfaces can be uniformly biased against the electronic components. As discussed above with reference to FIGS. 1-4, the mounting surfaces of the cantilever portions 16 and 18 of the heat sink 12 can be disposed against one or more electronic components 20 and 22, such as a plurality of processors.

In certain embodiments, the conductive member 62 of the heat sink 12 includes additional heat transfer mechanisms, such as circulating vapor chambers or heat pipes. In this exemplary embodiment, the heat sink 12 includes heat pipes 130 in some of the receptacles 132 disposed on the bottom 46 of the heat sink 12. The receptacles 132 are constructed in the conductive member 62 of the heat sink 12. The illustrated heat pipes 130 extend from the cantilever portions 16 and 18 lengthwise along the heat sink 12 to the base end 26 of the heat sink 12, such that the heat pipes 130 transfer heat from the cantilever portions 16 and 18 throughout the base 24 (see FIGS. 1-3). In other words, the heat pipes 130 supplement the thermal conduction from the cantilever portions 16 and 18 to the base end 26, thereby increasing the heat distribution throughout the heat sink 12. The fins or convective members 60, in turn, convectively dissipate this heat with the aid of the blowers, for example. Although not illustrated, a vapor chamber may be disposed in the conductive member 62 in addition, or in lieu of, the heat pipes 130 and receptacles 132. For example, the conductive member 62 can include one or more closed chambers or passages containing an amount of fluid, such that heat is absorbed at one end (i.e., the cantilever ends 28 and 30) by vaporization of the fluid and the heat is released at the other end (i.e., at the base end 26) by condensation of the vapor. The condensed fluid then circulates back to the cantilever ends 28 and 30, and the cycle repeats.

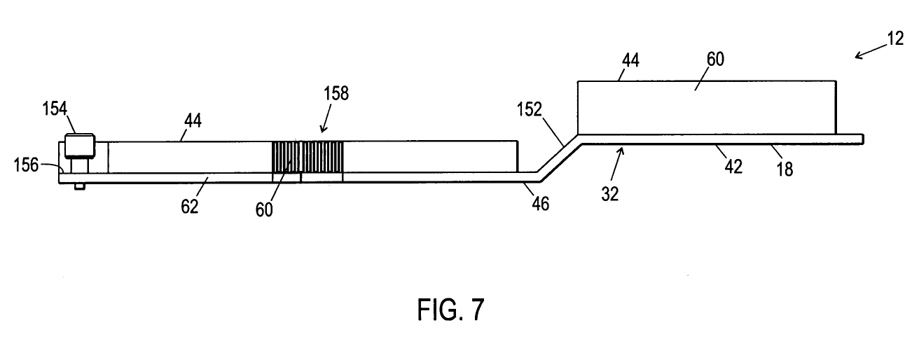

FIGS. 6 and 7 are a top view and a side view, respectively, of an alternate configuration of the heat sink 12 having a cantilever cut 14 in accordance with certain embodiments. The base 24 is stepped from the cantilever portions 16 and 18 via a slope 152 of the conductive member 62 of the heat sink 12. Such a configuration may facilitate mounting of the heat sink 12 and other items, such as fans or blowers, along the top 44 of the heat sink 12, along the base 24, and so on. Moreover, the two-tier structure of the heat sink allows the lower-tier to be coupled to the housing, thereby facilitating heat transfer into the housing for greater heat dissipation.

The heat sink 12 includes exemplary thumbscrews 154 inserted through holes in recessed areas 156 of the heat sink 12. The thumbscrews 154 and exemplary notches 158 may be utilized to secure and mount the heat sink 12 within an electronic device. Further, the heat sink 12 may be configured to reside on a fulcrum structure disposed underneath the heat sink 12 along a fulcrum axis 32 of the heat sink 12. On the other hand, a fulcrum structure may be inserted through the heat sink 12 (see, e.g., FIG. 3). The thumbscrews 154, notches 158, and exemplary toe-in notches 80 facilitate effective mounting of the cantilever portions 16 and 18 of the heat sink 12 on electronic components.

The heat sink 12 includes component mounting surfaces (e.g., surface 42 on portion 18) on the bottom of the cantilever portions 16 and 18. Further, base 24 portion extends laterally from the cantilever portions 16 and 18. Thus, the heat sink 12 extends across and away from electronic components (not shown) that interface with the mounting surfaces (e.g., surface 42) on the cantilever portions 16 and 18. Again, the cantilever portions 16 and 18 and the base 24 portion significantly increase the cooling capacity of the heat sink 12 in comparison to a simple top-mount heat sink, because the heat sink 12 has a greater volume for thermal conduction and a greater surface area for thermal convection. In operation, the heat sink 12 dissipates heat generated by the components (not shown) by transferring the heat along the length of the base 24, such that the fins 60 convectively transfer the heat away from the heat sink 12. In addition, certain embodiments of the base 24 include one or more circulating heat pipes or vapor chambers, which supplement the conductive heat transfer of the base 24.

1. A computer system, comprising:
first and second electronic components; and
a cantilevered heat sink comprising:
a first cantilever portion having a first contact surface disposed against the first electronic component; and
a second cantilever portion having a second contact surface disposed against the second electronic component.

2. The computer system of claim 1, comprising a fulcrum structure disposed along a fulcrum axis of the cantilevered heat sink.

3. The computer system of claim 2, wherein the fulcrum structure comprises a spring mechanism.

4. The computer system of claim 1, wherein the first electronic component has a different height than the second electronic component relative to the cantilevered heat sink.

5. The computer system of claim 1, comprising a thermal Interface material (TIM) disposed between the first contact surface and the first electronic component, and disposed between the second contact surface and the second electronic component.

6. The computer system of claim 1, comprising fastening elements operable to adjust compression of the first and second contacts surfaces against the first and second electronic components, respectively.

7. The computer system of claim 1, wherein the first and second electronic components comprise processors.

8. The computer system of claim 1, wherein the heat sink comprises a base portion combining the first and second cantilever portions.

9. The computer system of claim 1, wherein the heat sink comprises protruding members.

10. (canceled)

11. The computer system of claim 1, wherein the cantilevered heat sink comprises a closed passage having a fluid that vaporizes to absorb heat at one region and that condenses to release heat at another region away from the first region.

12. The computer system of claim 11, wherein the closed passage comprises a heat pipe.

13. A heat sink for a computer, comprising:
a thermally conductive member having first and second cantilever portions coupled to a base portion, wherein the first and second cantilever portions are configured to contact surfaces of first and second electronic components, respectively and wherein the contact surfaces of the first and second electronic components are at differing heights.

14. The heat sink of claim 13, comprising fastening elements configured to mate with mounting hardware within an electronic device, wherein the fastening elements are operable to adjust the compression of the first and second cantilever portions against the first and second electronic components, respectively.

15. The heat sink of claim 13, comprising convective members disposed on the thermally conductive member.

16. The heat sink of claim 13, wherein the first and second cantilever portions are relatively higher than the base portion.

17. The heat sink of claim 13, wherein the thermally conductive member comprises an enclosed working fluid to facilitate heat transfer by vaporization and condensation between different regions.

18. A method of operating an electronic device, comprising:
conducting heat from first and second electronic components through a thermally conductive member comprising first and second cantilever portions disposed on the first and second electronic components, wherein the thermally conductive plate comprises a lateral portion extending from the first and second cantilever portions; and
convecting heat from the thermally conductive member via convective members.

19. (canceled)

20. The method of claim 18, comprising evaporating a working fluid within a passage at a first region adjacent the first or second electronic component, and condensing the working fluid in the passage at a second region away from the first region and the first and second electronic components.
